(19) United States
(12) Patent Application Publication
(10) Pub. No.: US 2024/0219725 A1
(43) Pub. Date: Jul. 4, 2024

(54) DEVICE FOR PROJECTING AN IMAGE FORMED BY A SCREEN

(71) Applicant: COMMISSARIAT A L'ENERGIE ATOMIQUE ET AUX ENERGIES ALTERNATIVES, Paris (FR)

(72) Inventor: Christophe MARTINEZ, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/398,391

(22) Filed: Dec. 28, 2023

(30) Foreign Application Priority Data
Dec. 29, 2022 (FR) 22 14637

(51) Int. Cl. G02B 27/01; G02F 1/29

(52) U.S. Cl. CPC G02B 27/0172; G02F 1/292; G02B 2027/0174; G02B 2027/0178

(57) ABSTRACT

Device (1) for projecting an image onto an eye (O), comprising:
a light emitter, along various emission axes;
an optical combiner (30), configured to form, from each light wave, a collimated light wave;
   the device being such that:
the light emitter comprises a directional screen (10), comprising various pixels (10ᵢ), configured to emit a divergent light wave along a predefined emission axis;
the combiner has an object focal plane;
the directional screen is placed in the object focal plane of the combiner;
the optical combiner is configured to receive each light wave emitted by a pixel and to form a collimated light wave that propagates towards a central position (C3);
the respective emission axes of various pixels of the directional screen converge to the same target point, downstream of the combiner;
FIG. 2A

### TECHNICAL FIELD

The technical field of the invention relates to a directional screen and use thereof in a device for projecting an image onto an eye, for example In augmented-reality applications.

### PRIOR ART

Wearable augmented-reality devices, such as glasses, allow a real scene to be observed while complementary information is viewed. This type of device is frequently based on micro-displays, allowing an image to be formed in Immediate proximity to an eye of a user. Such micro-displays may for example be integrated into a pair of glasses. An optical system, comprising a set of lenses, allows a clear image to be perceived by the eye.

The U.S. Pat. No. 9,632,317, and the publication Martinez “See-trough holographic retinal projection display concept”, Optica, Vol. 5 No. 10, Oct. 2018, describe a device allowing projection, onto the retina of an eye, without a screen or an optical system. The device comprises a transparent integrated optical circuit composed of an array of nanoscale light guides, of an array of electrodes and of a holographic film. Such a device is compact, and allows a large field of view to be obtained. In addition, it makes it possible not to use bulky optical systems of complex design.

The light guides allow a set of emission points to be defined on the holographic film, each point being capable of being illuminated by light extracted from one light guide. The set of emission points is subdivided into various subsets, each subset comprising emission points distributed, as randomly as possible, over the holographic film. The emission points of a given subset may be simultaneously illuminated by various light guides. Under the effect of illumination, each emission point of the same subset emits a light wave that propagates in a given direction to the pupil of the eye, so as to form a single spot of light on the retina. In this way, each subset of emission points allows a pixel of the image perceived by the user to be formed. An image may be formed by successively illuminating various subsets of points, so as to form an image comprising a high number of pixels.

Such a configuration makes it possible to form a very compact device. However, this presupposes use of a high number of different laser sources.

Other technologies have been described that allow an image to be projected onto an eye using a compact device. The patent U.S. Ser. No. 10/254,547 for example describes a telescope comprising a device for projecting a virtual image. The operating principle is schematically shown in FIG. 1. A light emitter E is place on the frame M of a pair of glasses. The light emitter E generates light beams F that propagate towards a holographic reflector H. The holographic reflector H is formed on the lens of the glasses. It is configured to reflect each light beam towards the pupil P of an eye O of a user. The light emitter is formed by a light source coupled to a movable mirror. The movable mirror is moved, so as to successively form light beams that scan the holographic reflector. Thus, the user perceives reflected light beams, of various angular directions. When the Intensity of each beam is modulated during the scan, the user perceives an image.

Other documents describe configurations in which a light beam scans a holographic reflector. Mention may for example be made of US201910285897 or US20180299680.

One drawback of scan-based configurations is that the eye box is small in size. An eye box is a volume in which the eye may be moved while still perceiving a sharp image. The movement of the eye may be dynamic, when the eye is rotated to scan the field of view. It may also vary from one user to another because of the differences between the interpupillary distances. With a small eye box, a device may be suitable for one user but not for another, for example if the two users have different interpupillary distances.

Another drawback is related to the need to use a mechanical system to perform the scan. Use of a mechanical scanning system and of moving components increases the complexity and cost of the device.

The Inventors provide an alternative configuration to the aforementioned scanning-based projecting devices. The objective is to provide a solution free of moving components, while Improving comfort of use, by Increasing the size of the eye box.

### SUMMARY OF THE INVENTION

One subject of the invention is a device for projecting an image onto an eye, the device comprising:
a light emitter, configured to emit light waves along various respective emission axes;
an optical combiner, optically coupled to the light emitter, and configured to form, from each light wave emitted by the light emitter, a collimated light wave that propagates towards the pupil of the eye;
   wherein:
the combiner has an object focal plane;
the light emitter comprises a directional screen, comprising various pixels, each pixel being configured to emit a divergent light wave along a predefined emission axis, the light wave propagating such as to make a predefined divergence angle to the emission axis;
the directional screen is placed in the object focal plane of the combiner;
the optical combiner is configured to receive each light wave emitted by a pixel and to form a collimated light wave that propagates towards a position likely to be occupied by the pupil of the eye;
the respective emission axes of various pixels of the directional screen converge to the same target point, downstream of the combiner;
the image of the target point, formed by the combiner, corresponds to the position likely to be occupied by the pupil of the eye.

According to one possibility, the screen comprises a stack comprising:
light guides, each light guide being coupled to a plurality of diffraction gratings that are distributed over the length of the light guide, each diffraction grating being electrically modulatable, each diffraction grating being configured to be electrically modulated so as to extract light propagating through the light guide;
electrodes, each electrode being associated with a plurality of diffraction gratings coupled to various light guides, respectively, each electrode being configured to modulate each diffraction grating with which it is associated;
   each pixel of the screen corresponding to an association between an electrode and a diffraction grating coupled to a light guide;
   so that, under the effect of illumination by light extracted from the light guide, each pixel is configured to emit a divergent light wave that propagates around an emission axis of the pixel, thereby forming an emission cone, defined by a divergence angle around the emission axis of the pixel.

The screen may comprise a holographic film, which is subdivided into various elementary regions, each elementary region being associated with the diffraction grating of one pixel, and being configured to emit the divergent light wave, along the emission axis and the divergence angle of the pixel, under the effect of light extracted by the diffraction grating with which it is associated.

According to one embodiment:
a plurality of light guides are connected to the same light source;
a light modulator les between the light source and each light guide, so as to modulate an Intensity of the light emitted by the light source and fed to the light guide.

The screen may comprise a plurality of light sources, each light source being optically connected to a plurality of light guides. Various light sources may be configured to emit light at various respective wavelengths.

The pixels may be arranged in:
rows, each row being defined by one light guide, the light guide extending over the length of various pixels in the row;
columns, each column being defined by one electrode, the electrode extending over the length of various pixels over the length of the column.

According to one embodiment:
the combiner extends around an optical axis;
the pixels of the screen are segmented into groups of pixels;
the emission axes of the pixels of a given group of pixels converge to the same target point associated with the group of pixels;
two different groups of pixels are associated with two different target points, at least one target point associated with a group of pixels being distant from the optical axis.

The optical axis may pass through the centre of the combiner. The optical axis may extend between the centre of the combiner and the position likely to be occupied by the pupil of the eye.

According to one embodiment:
the screen comprises a first group of pixels, the emission axes of which converge to a first target point, the first group of pixels being configured to form a first portion of an image when the pupil of the eye occupies a first position;
the screen comprises a second group of pixels, the emission axes of which converge to a second target point, different from the first target point, the second group of pixels being configured to form a second portion of the image when the pupil of the eye occupies a second position, angularly offset from the first position.

According to one embodiment:
the screen comprises a first group of pixels, the emission axes of which converge to a first target point, the first group of pixels being configured to form an image when the pupil of the eye occupies a first position;
the screen comprises a second group of pixels, the emission axes of which converge to a second target point, different from the first target point, the second group of pixels being configured to form the image when the pupil of the eye occupies a second position, different from the first position.

According to one embodiment:
the pixels of the screen are segmented into macro-pixels, the pixels of a given macro-pixel being configured to display the same content;
the emission axes of the pixels of a given macro-pixel target various target points;
the respective emission axes of the pixels of various macro-pixels converge to the same target point.

The combiner is advantageously a holographic combiner.

According to one possibility:
the screen emits light in at least one emission spectral band;
the holographic combiner is transparent outside of the or each emission spectral band;
the holographic combiner forms a convergent lens in the or each emission spectral band.

The holographic combiner may form a reflector in the or each emission spectral band.

By collimated light wave, what is meant is a light wave the divergence or convergence of which is weak enough for the wave to be considered to be formed from beams propagating parallel to one another. By weak divergence or convergence, what is meant is making a divergence (or convergence) angle of less than 2° or than 1°.

The invention will be better understood on reading the description of the examples of embodiments that are presented, in the rest of the description, with reference to the figures listed below.

### FIGURES

FIG. 1 shows a prior-art configuration.

FIG. 2A is an optical schematic of a device according to the invention.

FIG. 2B is a ray trace drawn for the device shown in FIG. 2A.

FIG. 2C shows one example of placement on the lens of a pair of glasses.

FIG. 3A schematically shows the angular emission characteristics of pixels of a directional screen.

FIG. 3B shows the structure of a directional screen.

FIG. 4 shows a hologram of a directional screen being recorded.

FIG. 5A shows a layer of a directional screen, in which layer light guides are formed.

FIG. 5B shows a layer of a directional screen, in which layer electrically activatable diffraction gratings coupled to electrodes have been formed.

FIG. 5C shows a layer of a directional screen comprising previously recorded holograms.

FIG. 5D shows a variant of a directional screen allowing various light sources, potentially emitting in various spectral bands, to be used.

FIGS. 6A to 6F schematically show the various layers forming a directional screen.

FIG. 7A is an optical schematic of a convergent lens.

FIG. 7B shows a phase of recording one portion of the holographic lens.

FIG. 7C shows a use of the holographic lens.

FIGS. 8A to 8G show a variant making it possible to duplicate an eye box of the device.

FIG. 8A and FIG. 8C show configurations in which the eye is placed facing two respective angular directions.

FIGS. 86 and 8D illustrate images perceived by the eye in the respective configurations Illustrated in FIGS. 8A and 8C.

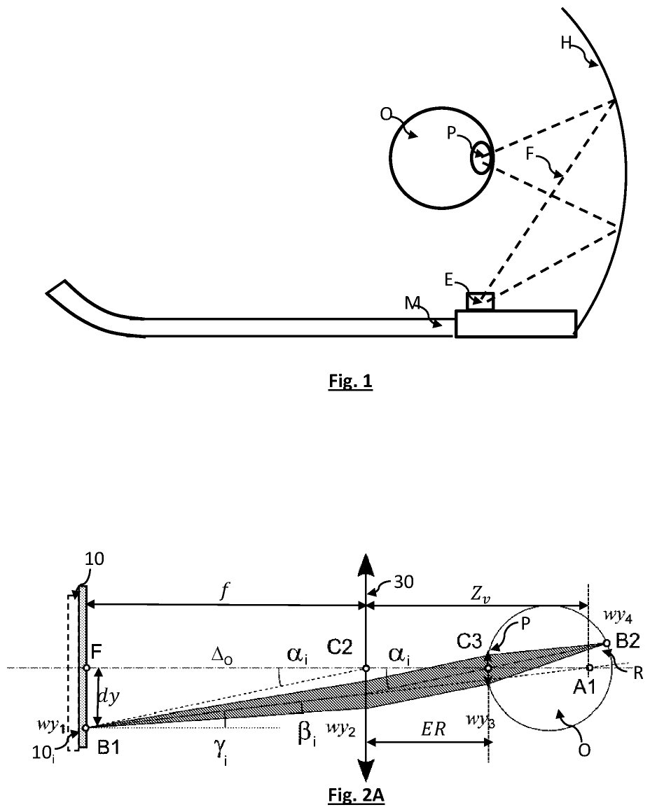

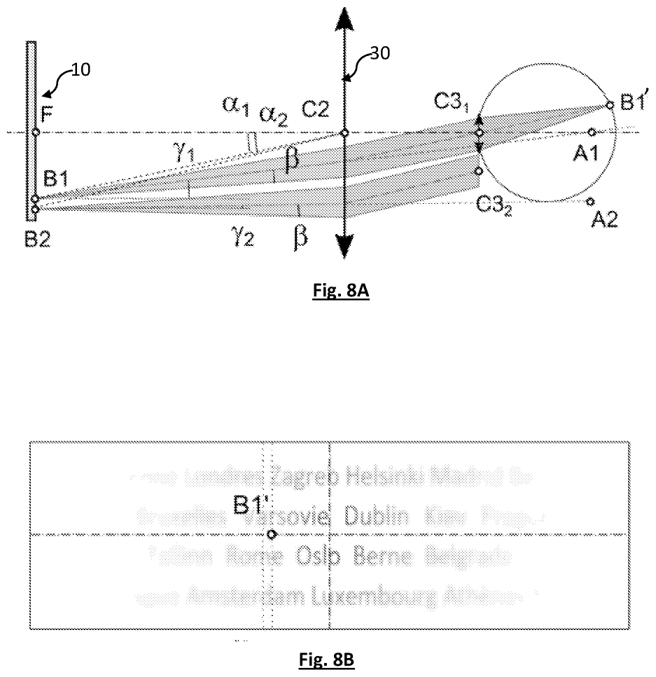

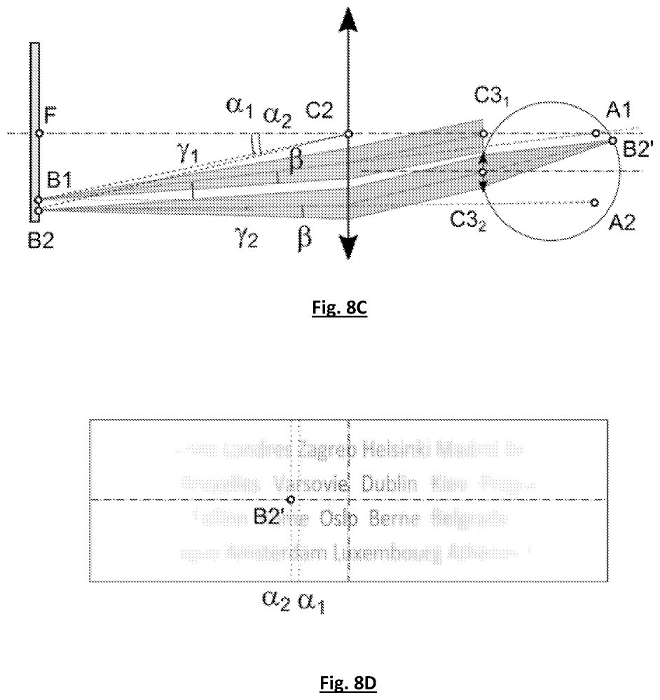

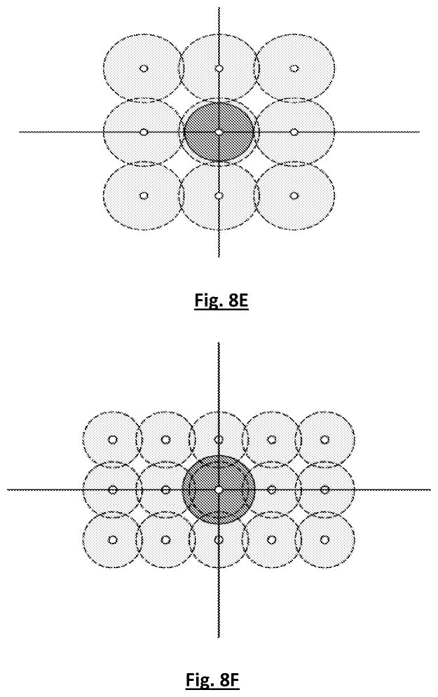

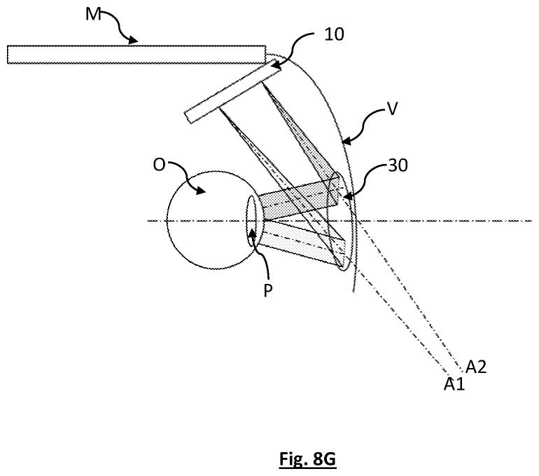

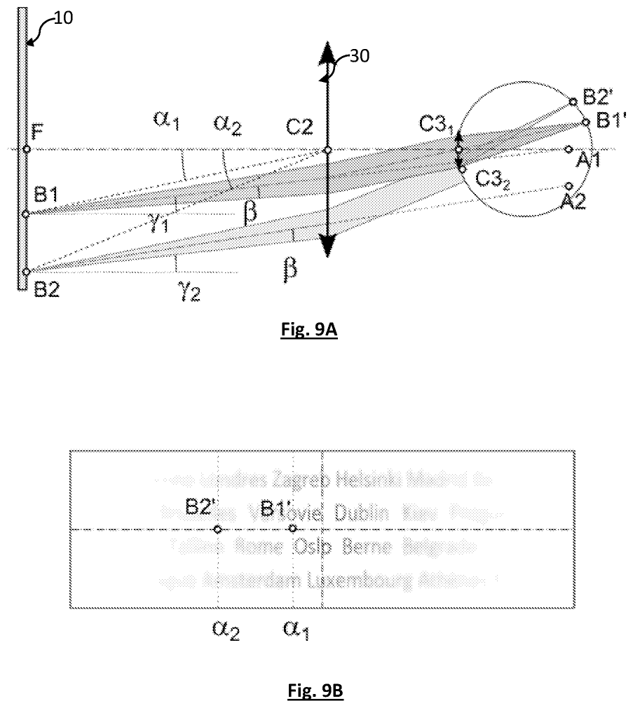

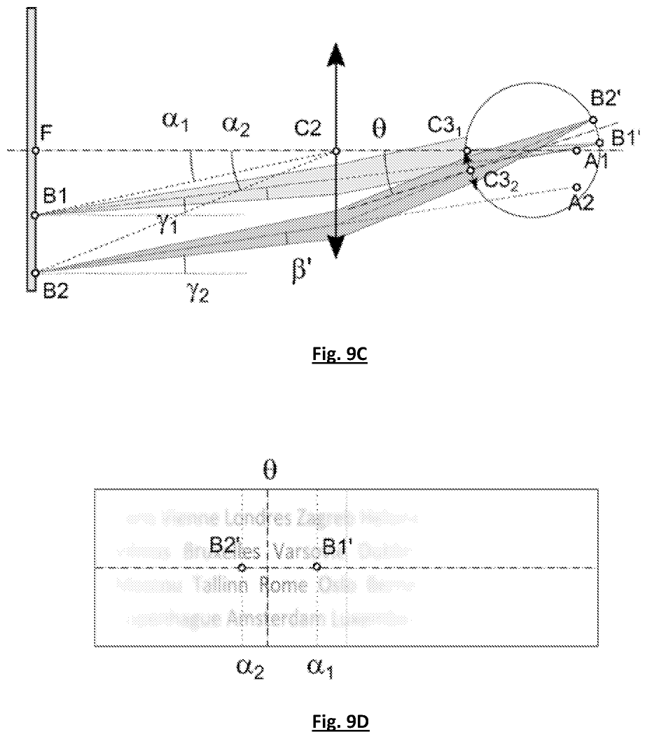

FIGS. 8E and 8F show different configurations, with different numbers of duplication of the eye box.

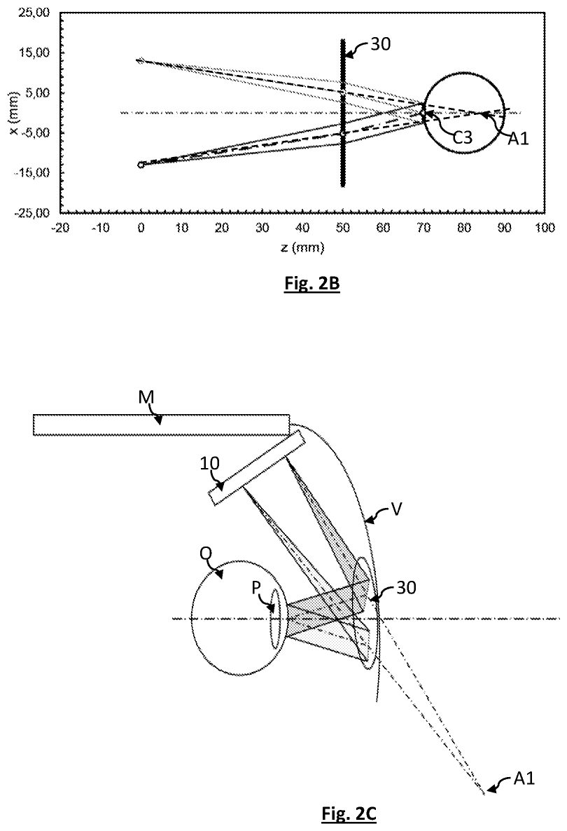

FIG. 8G schematically shows the embodiment described with reference to FIGS. 8A to 8F, in a reflection configuration, as described with reference to FIG. 2C.

FIGS. 9A to 9D show another variant making it possible to Increase the size of the eye box.

FIG. 9A and FIG. 9C show configurations in which the eye is placed facing two respective angular directions.

FIGS. 9B and 9D Illustrate images perceived by the eye in the respective configurations Illustrated in FIGS. 9A and 9C.

### DESCRIPTION OF PARTICULAR EMBODIMENTS

FIG. 2A schematically shows the main elements of a device 1 according to the invention. The device comprises a screen 10, comprising pixels 10ᵢ. In FIG. 2A, the point B1 designates a pixel. The screen 10 is a directional screen. The term directional screen designates a screen each pixel of which is configured to emit a divergent light wave along an emission axis, making an emission angle to a direction normal to the screen, the light wave propagating such as to make a divergence angle to the emission axis, the screen being such that:
the divergence angle is predetermined, and preferably less than 45° or less than 30°;
and/or the emission axes of two different pixels are different;
and/or the divergence angles of two different pixels are different;
and/or at least one emission axis of a pixel is inclined with respect to the direction normal to the screen.

Thus, each pixel 10ᵢ emits, in an emission spectral band, a divergent light wave that propagates along an emission axis Δᵢ. The emission axis Δᵢ is inclined by an emission angle γᵢ with respect to a direction perpendicular to the screen. The respective emission spectral bands of each pixel may be identical or different from one another.

The device comprises a combiner 30. The term combiner designates a component that combines both an optical function providing transparency, in a spectral band of transparency, and an optical function for steering, in a spectral band of Interest, which is preferably narrow, and possibly for shaping an optical beam, generated off the viewing axis by the screen. The viewing axis corresponds to an axis centred on and perpendicular to the exit pupil. The combiner may perform, in one or each spectral band of Interest, the optical function of mirror type and the forming function of convergent lens type. Outside these spectral bands, the component is transparent and the optical beams pass through it without notable disturbance.

FIG. 2A schematically shows an “unfolded” optical schematic, in which the combiner 30 is shown operating in transmission. To a divergent Incident light wave, the combiner 30 takes the form of a lens forming a collimated light wave, or one that may be considered as such, i.e. one that is weakly divergent. By weakly divergent, what is meant is a wave the divergence angle of which is less than 1°. This makes it possible to form, in the eye, an image “at a large distance”, i.e. a distance of more than 2 m.

The combiner is configured to form, from each light wave emitted by a pixel, a collimated light wave that propagates towards the pupil of the eye of the user. Preferably, the combiner is a holographic combiner, the lens function and the mirror function being encoded in a hologram formed over the length of the combiner.

Use of a holographic combiner is known to those skilled in the art. A holographic combiner has the advantage of being compact, because it is formed by a thin holographic layer deposited on a carrier, such as a lens of a pair of glasses. A holographic combiner is highly wavelength selective. The hologram is transparent to most of the visible spectrum, except for a specific wavelength to which it is sensitive. The convergence function of the combiner, and likewise the function ensuring angular deviation, are encoded into the hologram, as described below.

The holographic combiner 30 defines an object focal plane and an image focal plane. The pixels of the screen 10 are placed in the object focal plane of the combiner.

According to the embodiment shown in FIG. 2A, the emission axes of all the pixels of the screen converge to the same virtual point A1. FIG. 2B shows the emission axes of two different pixels. The virtual point A1 is such that its image, as a result of the combiner 30, is positioned at a point C3. The point C3 corresponds to a position at which the user places the pupil P of his eye O. Thus, the beam delivered by each pixel is collimated by the combiner, and directed towards the point C3 in such a way as to be centred on the latter. It will be understood that the emission angle associated with each pixel is adjusted so as to converge to the virtual point A1.

Thus, each pixel 10ᵢ of the screen 10 is configured to emit a light wave, around an emission axis Δᵢ the emission angle γᵢ of which is such that the emission axis Δᵢ passes through the virtual point A1. As a result, the respective emission angles of various pixels 10 are different from one another and converge to the virtual point A1. Each emission angle may be defined with respect to an optical axis Δ₀, passing through the centre of the combiner C2 and through the previously defined point C3. In the example shown, the optical axis Δ₀ passes through the centre of the screen, although this is not essential.

In FIG. 2A, the notations wy₁, wy₂, wy₃, denote the beam sizes of the light wave, with respect to the axis of propagation of the beam, from the light wave emitted by the pixel 10ᵢ, in planes parallel to the plane In which the combiner extends, and passing through the points B1, C2, and C3, respectively. The screen 10 lies in the object focal plane of the combiner, while being perpendicular to the optical axis Δ₀. The collimated light wave resulting from each pixel 10ᵢ reaches the point C3 at an angle of inclination αᵢ with respect to the optical axis Δ₀. The distance between the pixel 10ᵢ and the optical axis Δ₀ is denoted dy.

The collimated light wave resulting from the combiner is focused by the eye O so as to form a pixel of an image of the screen, which image is formed on the retina R of the eye. The pixel of the image formed on the retina corresponds to point B2. The position of B2 is defined by the angle of inclination αᵢ, the latter being different for each pixel 10ᵢ. It will be understood that the device allows the image formed by the screen 10 to be formed on the retina R.

The combiner makes it possible to generate a wave that is coillmated at the eye so that when the user looks at a faraway object (eye/object distance large with respect to the size of the eye), for example the peak of a mountain, the user may also perceive the image of the screen, the latter generating information of augmented-reality type, for example the name of the peak and its altitude. The notion of collimation is therefore relative. Although theoretically associated with an image placed at Infinity, this notion may also be applied to an image placed at a large distance (typically beyond 100 times the size of the eye, i.e. about 2 meters from the observer).

Let Z_{ν} be the distance between the virtual point A1 and the point F positioned on the screen. Let f be the focal length of the combiner (distance between C2 and the screen).

The emission angle γᵢ of each pixel 10ᵢ and the inclination angle αᵢ are such that:

$$\\ \begin{matrix}{γ}_{i} = {tan}^{- 1} ( \frac{dy}{{Z}_{v}} ) and & ( 1 )\end{matrix}$$

$$\\ \begin{matrix}{α}_{i} = {tan}^{- 1} ( \frac{dy}{f} ) & ( 2 )\end{matrix}$$

The size of the eye box, which depends on the divergence angle βᵢ of each pixel, is such that:

$$\\ \begin{matrix}E B = 2 \times f \times tan ( {β}_{i} ) & ( 3 )\end{matrix}$$

Preferably, each pixel of the directional screen is configured so as to have the same divergence angle.

FIG. 2C shows what is referred to as a folded configuration, in which the combiner acts as a reflector. The combiner is integrated into the lens V of a pair of glasses. The screen 10 is securely fastened to the frame M of the glasses. The emission axes of all the pixels of the screen converge to the same point A1. The collimated beams resulting from the combiner 30 and propagating towards the pupil of the eye have been shown.

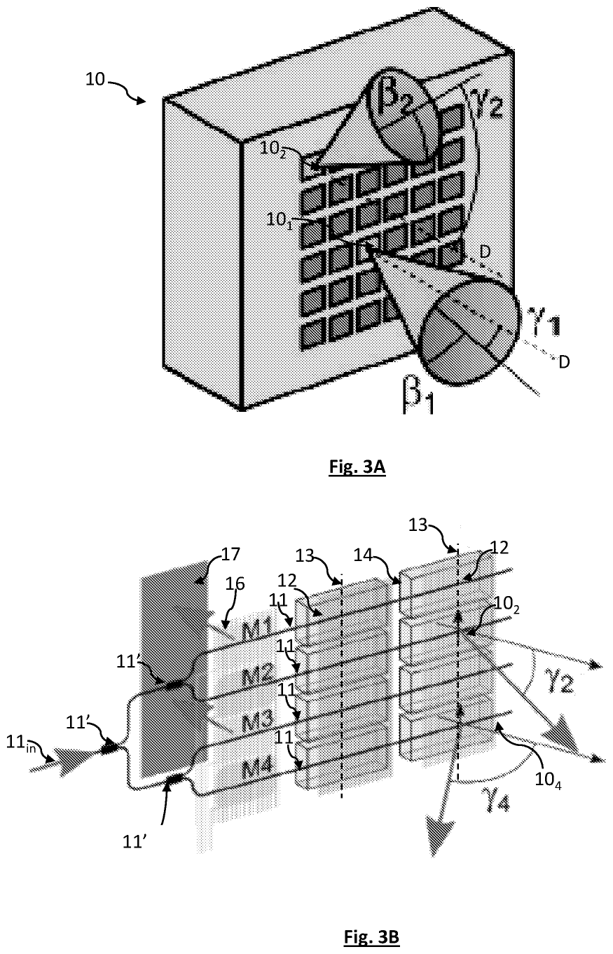

FIGS. 3A and 36 show operation of the directional screen 10. The directional screen is formed by a plurality of pixels 10ᵢ, which are preferably arranged in rows and columns. Each pixel is configured to emit a light wave at an emission angle, with respect to a direction D normal to the plane in which the screen Iles. In FIG. 3A, the following have been shown:
a pixel 10₁, emitting a divergent light wave propagating along an axis of propagation making an emission angle γ₁ to the direction D, and forming a cone the half-angle at the apex of which is denoted β₁ and called the divergence angle;
a pixel 10₂, emitting a divergent light wave propagating along an axis of propagation making an emission angle γ₂ to the direction D, and making a divergence angle β₂.

FIG. 3B schematically shows a structure of the directional screen. The directional screen comprises light guides 11. Each light guide 11 is connected to one light source 11ᵢₙ. Unlike the configuration described in U.S. Pat. No. 9,632,317, the light source 11ᵢₙ may be a laser source, but also a non-coherent source, for example a light-emitting diode. In the example shown, each light guide extends along a row, and more precisely over the length of various pixels of the row. The light guides may for example be formed from SIN (silicon nitride), deposited in a layer of SiO₂.

The screen comprises:
a first layer, in which light guides 11 are formed. The light guides are configured to receive light emitted by the light source 11ᵢₙ;
a second layer, in which diffraction gratings 12 are formed, such that each diffraction grating 12 is coupled to one light guide 11. The diffraction gratings 12 are electrically modulated. Each diffraction grating 12 corresponds to a periodic variation in refractive index, capable of being electrically modulated. The diffraction gratings 12 coupled to a given light guide 11 are spaced apart from one another over the length of the light guide, and are considered to be discrete. Each diffraction grating 12 may be formed from inclusions, defining a periodic pattern, in silicon oxide (SiO₂), each inclusion being formed from a material the refractive index of which is electrically modulatable, a liquid-crystal for example. When the wavelength of the light is 532 nm, the period of the pattern of the diffraction grating 12 may be comprised between 200 nm and 500 nm. A diffraction grating may be made up of 10 periodic patterns, and thus extend over a length of 2 or 5 μm;
a third layer, in which transparent electrodes 13 are formed, the electrodes being configured to electrically modulate the refractive index of a material forming the diffraction gratings. The transparent electrodes may be formed from a transparent conductive material, for example ITO (Indium tin oxide). Each electrode may thus activate one diffraction grating under the effect of electrical modulation. In the example shown, the transparent electrodes extend parallel to columns;
a fourth layer, referred to as the holographic layer, corresponding to a holographic film 14. By holographic film, what is meant is a photosensitive medium capable of recording a hologram. The holographic film is assumed to be thin enough to be likened to the emission surface. The holographic film may be a photopolymer of photoresist type or a suspension of light-sensitive compounds such as silver halide.

The layers are formed on a transparent carrier. It may for example be a carrier made of glass or of polycarbonate.

Under the effect of biasing by an electrode 13, each discrete diffraction grating 12 is activated, in the sense that it allows some of the light propagating through a light guide 11 to which the diffraction grating 12 is coupled to be extracted. The extracted light propagates towards the holographic film 14, and more precisely towards an elementary region 141 of the holographic film 14. Under the effect of illumination, the elementary region of the holographic film emits a light wave with predefined angular characteristics. By angular characteristics, what is meant is an emission angle γᵢ and a divergence angle βᵢ.

Thus, each pixel 10ᵢ of the screen corresponds to a superposition of a discrete diffraction grating 12 coupled to a light guide 11, and of an electrode 13, facing an elementary region 14ᵢ of the holographic film 14. The association between each electrode 13 and each diffraction grating 12 forms a structure for extracting some of the light propagating through a light guide 11.

In the example shown, the light guides 11 are coplanar. The same goes for the electrodes 13. Thus, the electrodes 13 are superposed on the light guides 11. Each electrode “crosses” a plurality of light guides, so as to define a plurality of intersections, each intersection corresponding to one pixel of the screen. The term “to cross” is to be understood to designate a superposition of an electrode and of a light guide. The position of each pixel is defined by positioning the light guides and the electrodes. The angular emission characteristics are defined by the hologram forming the elementary region 141, which is illuminated by extracting light propagating through the light guide.

FIG. 3B shows a pixel 10₂ and a pixel 10₄. Each elementary region of the hologram facing these pixels is configured to emit a respective light wave with predefined angular characteristics, which are encoded into the hologram. FIG. 3B shows the emission angles γ₂ and γ₄ defined for the pixels 10₂ and 10₄. The angular emission characteristics may be defined, for each pixel, independently of the other pixels.

Splitters 11′, Y-junctions for example, may be placed so as to distribute the light emitted by a given light source 11ᵢₙ to various light guides 11. In order to modulate the Intensity of light propagating through a light guide, each light guide 11 may be coupled to a modulator. FIG. 3B shows four modulators M1, M2, M3 and M4. Each modulator comprises an extractor 16, which is configured to be electrically activatable, so as to extract all or some of the light propagating through a light guide. Each extractor may be similar to a diffraction grating 12 such as described above. When an extractor is activated, the light propagating through the light guide 11 is extracted, preferably to an absorber 17. The presence of the absorber makes it possible to dissipate the extracted light, in order to avoid propagation of a stray light through the screen 10. Use of modulators allows the Intensity of pixels of the screen that are activated simultaneously to be adjusted.

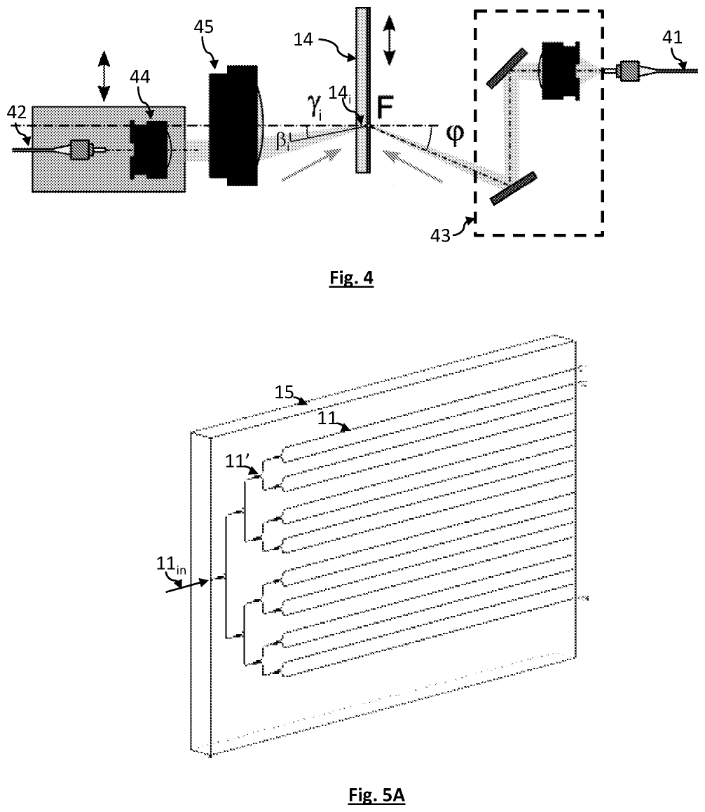

The angular emission characteristics of each pixel 10ᵢ are defined in a prior phase of recording the holographic film 14. As known, a hologram is formed by Interference between two light waves emitted by the same light source: an object light wave and a reference light wave. The Interference fringes generated are physically or chemically memorized in the holographic film 14. FIG. 4 shows an arrangement allowing an elementary region 141 of the holographic film 14 to be recorded.

A light source is coupled to two fibres by means of a splitter, so as to obtain a fibre forming an object beam 42 and a fibre forming a reference beam 41. The light source has a wavelength close to that of the light 11ᵢₙ to which the screen 10 is connected when in use. This source is typically a laser of long coherence length (longer than one meter).

The fibre forming the reference beam 41 reproduces illumination conditions similar to those obtained by extracting light from a light guide 11 by activating a diffraction grating 12. By illumination conditions, what is meant is the angle of incidence of the beam, its size and its divergence. The reference beam 41 is fixed and is formed by a reference beam-forming optical system 43.

The object beam is generated by an object beam-forming optical system 44 coupled to a convergent focusing optical unit 45. This makes it possible to adjust an angle of incidence γᵢ and a divergence angle βᵢ of the object beam. A hologram is recorded, in an elementary region 14ᵢ, by simultaneously exposing said elementary region to the object beam and to the reference beam. The various holograms are produced, in each elementary region, by moving the holographic film 14 and optionally modifying the characteristics of the object beam, in particular the angle of incidence γᵢ and the divergence angle βᵢ. Thus, each elementary region 14ᵢ is assigned an angle of incidence γᵢ and a divergence angle βᵢ that correspond to the angle of incidence and divergence angle of the object beam during recording of the hologram.

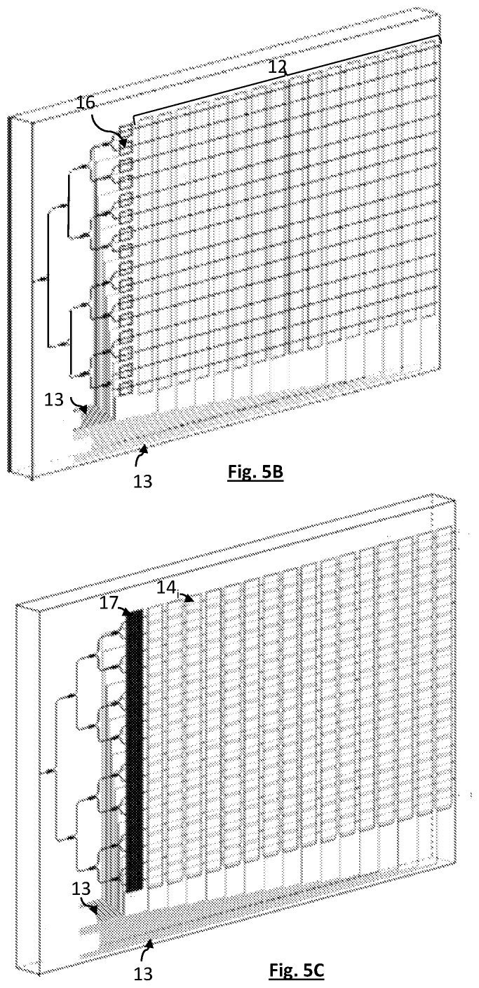

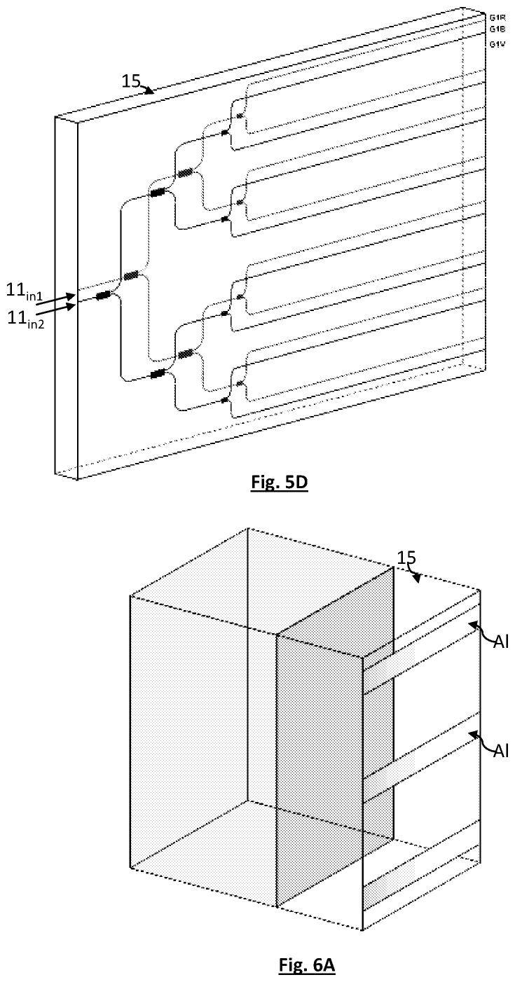

FIGS. 5A to 5D schematically show various layers mentioned above. FIG. 5A shows, formed on a glass substrate 15, a structured layer defining the light guides 11. FIG. 58 shows an extraction layer formed by the diffraction gratings 12, 16 described above. FIG. 5C shows a holographic layer comprising the holographic elementary regions 141 and the absorber 17.

One advantage of the holographic screen is that it reduces the number of light sources with respect to the configuration described in U.S. Pat. No. 9,632,317. The directional screen may be formed using a single light source. It is then monochrome. The directional screen may be formed using a plurality of light sources emitting in different spectral bands. Such a configuration is shown in FIG. 5D. A plurality of light guides may be formed, on the same layer, so as to form Independent arrays of light guides. Each light-guide array is Intended to be optically coupled to a light source emitting in a determined spectral band. FIG. 5D shows two light-guide arrays Intended to be optically coupled to two light sources 11ᵢₙ₁ and 11ᵢₙ₂. The various light guides may be produced on the same substrate 15. The arrangement of the light guides prevents cross-talk between the light guides at each intersection.

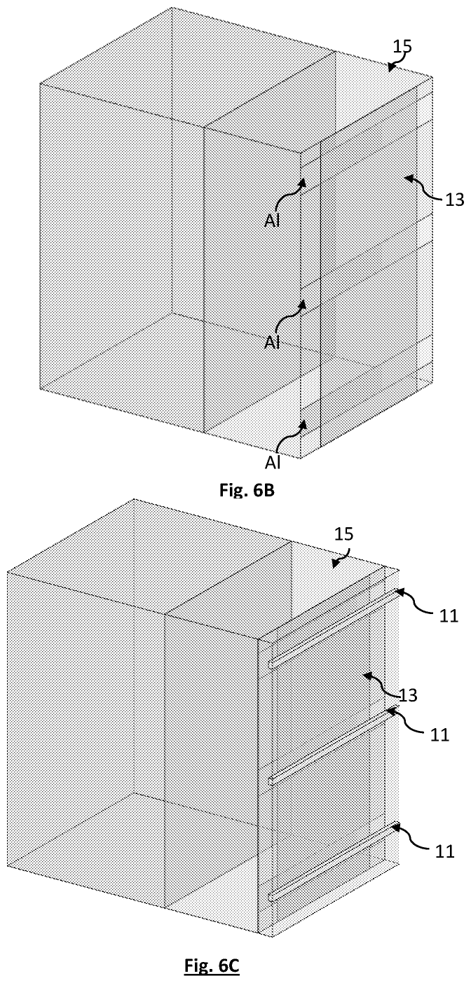

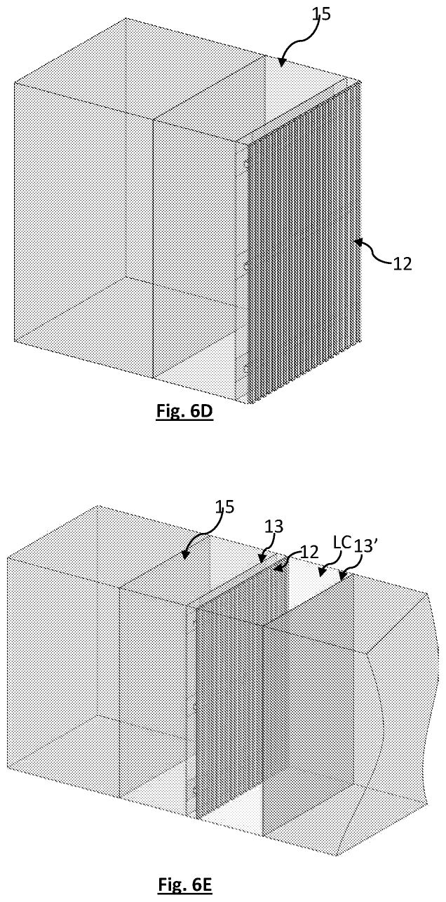

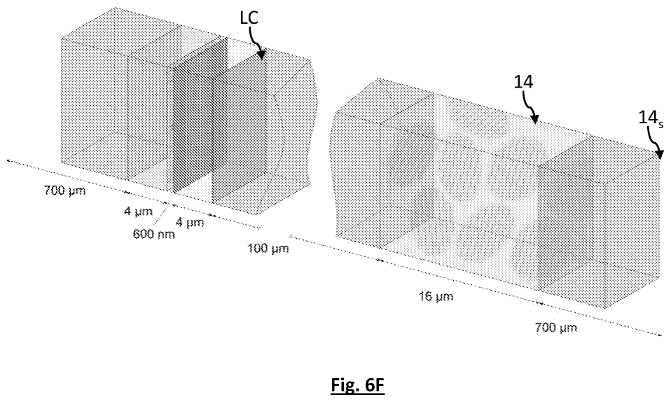

FIGS. 6A to 6F Illustrate the steps of manufacture of a directional screen 10. In FIG. 6A, strips of reflective material (for example a metal such as aluminium Al), which are Intended to act as a reflector, are deposited on a substrate 15, thereby forming rows. The aluminium strips, which are 1 μm wide, are spaced apart from each other by 5 μm.

FIG. 6B shows a layer of addressing electrodes 13, taking the form of a structured layer of ITO (indium-tin oxide) of 40 nm thickness. The ITO layer may be structured, so as to form electrodes extending in columns perpendicular to the rows.

FIG. 6C shows the deposition of an SiO₂ layer, in which SiN light guides are formed. The guides have a width of about 400 nm and a thickness of between 100 nm and 400 nm. The choice of SiN is Justified by its transparency in the visible domain.

FIG. 6D shows deposition of a structured layer Intended to form a diffraction grating 12. The diffraction grating is preferably formed from a material that is simple to structure, a sol-gel for example.

The diffraction grating is encapsulated in a liquid-crystal layer LC, the refractive index of which is able to switch between two values depending on the voltage applied by the electrodes. Depending on the value of the refractive index, the diffraction grating 12 allows light propagating through the light guide to be extracted. A transparent counter-electrode 13′, for example one made of ITO, deposited on a transparent film 13s (made of glass or of transparent plastic), is placed on the liquid-crystal layer. See FIG. 6E.

FIG. 6F shows deposition of a holographic layer 14, borne by a transparent carrier 14s, against the film 13s allowing the liquid crystal to be encapsulated. The holographic layer 14 may be formed from a photopolymer, of 15 μm thickness, while the carrier 14s may be formed from glass, of 700 μm thickness. The holographic layer 14 will have undergone recording beforehand, as described with reference to FIG. 4.

FIG. 6F shows all the layers forming the directional screen 10. The total thickness is of the order of 1.5 mm. The area of each pixel may be 5 μm×5 μm. It is thus possible to form a screen of 1920×1080 resolution the area of which is 10 mm×5 mm.

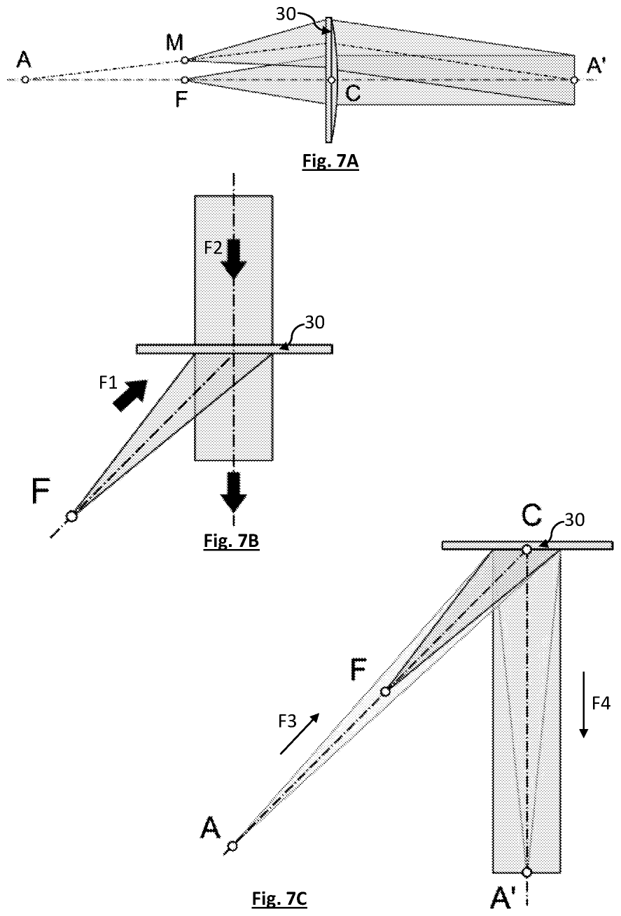

FIG. 7A details the operation of the holographic combiner 30, which behaves in a manner equivalent to a convergent lens. In FIG. 7A, the combiner conjugates point A′ with point A. The points F and M belong to the object focal plane. The light waves emitted by the points F and M are deflected to Infinity by the combiner. The point F corresponds to the focus of the lens. The point M is offset from the point F in the object focal plane. On exiting the lens, the beams passing through points F and M, respectively, are collimated and deviated angularly with respect to each other.

FIG. 7B Illustrates a phase of recording a hologram on the holographic combiner. An elementary region of the holographic material, forming the combiner, is exposed to a divergent reference beam F1, which is emitted from a point F, and to a collimated object beam F2, both beams being emitted by the same light source. The light source used, for example a laser source, is preferably coherent, and emits in a recording spectral band. The hologram resulting from the Interference between the beams F1 and F2 is stored in the holographic material. FIG. 7C shows use of the holographic combiner: under the effect of exposure to a divergent light beam F3 emitted from the point F, which corresponds to the focus of the lens, the previously stored hologram reflects a collimated light beam F4. If the beam F3 is emitted from a point A, distant from the focus F, the lens reflects a convergent beam to a point A′.

In the example described in FIGS. 7B and 7C, the holographic combiner forms a holographic lens reflecting light at the wavelength of the beams F1 and F2. The holographic combiner operates only in a narrow spectral band, which corresponds to the recording spectral band. Outside this spectral band, the holographic combiner transmits light. The holographic combiner may be placed on a lens of a pair of glasses or on a visor of a virtual-reality headset.

One example of dimensions is as follows:
eye relief (ER), which corresponds to the distance between the combiner and the eye: 20 mm;
distance Zν: 20 mm;
focal length of the combiner 30: 50 mm;
screen size: 13 mm×13 mm;
field of observation: 30°, this being the value obtained by applying (2) to the pixels furthest from the optical axis.

Each row or column of the screen may comprise 1920 pixels of 7 μm side length, this being a realistic dimension, while ensuring the image formed on the retina is of acceptable spatial resolution.

As described above, in connection with expression (3), the size of the eye box depends on the divergence angle β₁ assigned to each pixel. Considering a divergence angle of 3°, the eye box is a square of 5 mm side length, this being acceptable.

FIGS. 8A to 8E Illustrate a variant of the configuration schematically shown in FIG. 2A. In this variant:
the pixels 10i of the screen 10 are segmented into groups of pixels;
the emission axes Δᵢ of the pixels of a given group of pixels converge to the same target point associated with the group of pixels: in FIG. 8A two different target points A1, A2 have been shown;
two different groups of pixels are associated with two different target points, at least one target point associated with a group of pixels being distant from the optical axis.

In this embodiment, allowance is made for a movement of the eye with respect to the device. When rotating, the eye scans a wide angular range, while maintaining good vision quality.

It is considered that the user's eye will form a well-defined image in an angular field of 10° about the viewing axis, the latter being perpendicular to the pupil and centred on the latter.

The objective of this variant is to duplicate the eye box. In FIG. 8A, the pupil of the eye is placed at a point C3₁. FIG. 8B shows the visual field corresponding to this position. Two different respective target points A1 and A2 of two pixels B1 and B2 have been shown. The emission angle γ₁ of the pixel B1 converges to the virtual point A1 described with reference to FIG. 2A. The emission angle γ₂ of the pixel B2 converges to a virtual point A2, distinct from the point A1. FIG. 8A shows a schematic of propagation of the beams from the two pixels B1 and B2.

The spatial position of the pixels on the screen sets the angles α₁ and α₂, according to (2):

$$\\ {α}_{1} = {tan}^{- 1} ( \frac{{dy}_{1}}{f} ) and {α}_{2} = {tan}^{- 1} ( \frac{{dy}_{2}}{f} )$$

where dy₁ and dy₂ are the distances between the pixels and the optical axis defined by the combiner.

The two pixels B1 and B2 are neighbours on the screen, and have distances of separation of a few tens of microns α₁˜α₂. The emission axes of the two pixels are different: their respective emission angles γ₁ and γ₂ are defined so that pixel B1 targets point A1 and pixel B2 targets point A2.

Thus:

$$\\ {γ}_{1} = {tan}^{- 1} ( \frac{{hy}_{1}}{{Zv}_{1}} ) and {γ}_{2} = {tan}^{- 1} ( \frac{{hy}_{2}}{{Zv}_{2}} ) .$$

hy₁ and hy₂ are the distances, considered in the plane of the combiner, between the pixel and Its target point. Zν₁ and Zν₂ are the distances, along the optical axis, between the focal point and points A1 and A2.

For pixel B1, the target point A1 is on the optical axis of the combiner. Therefore hy₁=dy₁.

For pixel B2, the target point A2 is not on the optical axis of the combiner hy₂˜0.

According to this embodiment, each pixel Bᵢ of a given group of pixels targets a point Aᵢ the image of which, as generated by the combiner, is a point C3ᵢ corresponding to a potential position of the pupil of the user. The index i is an Integer varying between 1 and l, where l is the number of duplications of the eye box.

Pixels B1 and B2 have the same content and form a “macro-pixel.” A macro-pixel is a group of pixels that have the same content but target different target points, so that the pixels of the macro-pixel contribute to forming the same image In various respective positions of the retina. Each pixel of a macro-pixel is Intended to form the same image pixel In each image formed on the retina.

FIG. 8B shows an example of the visual field of an image projected into the eye. In this example, the image contains a list of names of European capitals. The image produced by pixel B1 is located at point B1′ at the angular coordinate α₁. This image shows a foveated rendering, reflecting the fact that, beyond an angle of about 5°, the image projected onto the retina is perceived by the brain with a low resolution.

The image emitted by pixel B2 does not enter the eye, or only very partially. Point B2′ has therefore not been shown In FIG. 86.

FIG. 8C shows the same device as discussed with reference to FIGS. 8A and 8B. The position of the eye corresponds to the point C3₂. This may be due to the fact that the optical system is being used by another user whose interpupillary distance is different. This may also be due to movement of the device on the user's head.

FIG. 8D shows an example of the visual field of an image projected into the eye when the position of the pupil corresponds to the point C3₂. The signal delivered by pixel B1 no longer enters the eye. The signal delivered by pixel B2 enters the eye and produces an image pixel B2′ located at the angle α₂ of the visual field. As α₁˜α₂ and this principle of pixel duplication is reproduced over the entire screen, the image perceived by the observer does not change or If so Imperceptibly.

According to this variant, the screen is covered with partially redundant pixels, forming the aforementioned groups of pixels. The pixels of a given group of pixels target the same point Ai, this allowing a pupil position C3ᵢ to be defined. The pixels of the various groups of pixels target various points Aᵢ, this allowing various pupil positions C3ᵢ to be defined.

The pixels are configured such that the image formed at point C3₂ is a replica of the image formed in the eye box centred on the point C3₁. Thus, the eye may move from point C3₁ to point C3₂ while perceiving the same image. In other words, the various groups of pixels, targeting various respective target points, are configured to form the same image. According to this embodiment, the user perceives the same image when his pupil occupies the first position C3₁ and when his pupil occupies the second position C3₂.

The higher the redundancy, the lower the resolution of the image but the easier it is to bring the optical system into adjustment, as a result of the many duplications of the eye box. FIGS. 8E and 8F show distributions of the eye box (abbreviated EB below) in the plane of the entrance pupil of the eye. The chosen number of replications of the EB will depend on the chosen divergence β of the beams, this divergence being set by a criterion related to energy conservation in the optical system.

In FIG. 8E, a high 0 value makes it possible to obtain an EB (dashed line shaded light grey) slightly larger than the size of the pupil of the eye (shown in dark grey). In this case, it has been chosen to duplicate the EB 3×3 times. Compared to a screen without EB replication, image resolution is decreased by a factor of 9.

In FIG. 8F, the size of the EB is slightly smaller than the size of the pupil of the eye. A replication favouring the horizontal direction has been chosen (this choice being consistent with human morphology). A 5×3 duplication has been employed, i.e. resolution is decreased by a factor of 15 with respect to an image formed with a screen without EB replication.

FIG. 8G Illustrates a folded configuration, in a manner analogous to FIG. 2C. FIG. 8G shows beams converging to two different points of the eye.

FIGS. 9A to 9D Illustrate another variant. FIGS. 9A and 9C show the schematic of propagation of the beams from two pixels B1 and B2. The same notations as used in FIGS. 8A and 8C have been adopted. Two different respective target points A1 and A2 of two pixels B1 and B2 have been shown. The image produced by pixel B1 is located at point B1′ at the angular coordinate α₁. The image produced by pixel B2 is located at point B2′ at the angular coordinate α₂. Unlike the preceding case, the positions of these pixels are sufficiently far apart that the angles α₁ and α₂ of projection of image pixels into the eye are different.

In the image formed on the retina, pixel B1 forms an image pixel B1′ at the limit of the angular field of 10° (apparent angle α equal to 10°). To view the pixels of the image displayed by the screen beyond the point B1′, for example the image pixel located at point B2′, the user turns his eye through an angle θ: cf. FIG. 9C. Thus, the centre of the pupil is no longer the point C3₁, but moves to the point C3₂. The emission angle of the pixel B2 is determined so as to target not the point A1, but the point A2, which is defined so as to allow continuity between the viewing angle of the image and the axis of the pupil of the user. Such an embodiment makes it possible to form a “wide angle” image on the screen, that the user may follow by turning his eye. The points targeted by the pixels of the screen are defined in such a way as to allow a gradual rotation of the user's pupil.

The angle α₂ targets an angular position in the visual field that is beyond the foveal region: the eye cannot perceive it with a good resolution when the pupil is located at point C3₁. The angle α₁ targets an angular position In the visual field that is on the periphery of the foveal region: the eye perceives it with a satisfactory resolution.

In FIG. 9A, the pupil of the eye is placed at a point C3₁ located on the optical axis. In FIG. 9C, the pupil of the eye is placed at a point C3₂ that is offset angularly from the optical axis by an angle θ.

If the beam delivered by the pixel B2 passed through the point C3₁, the produced image pixel B2′ would be rendered with a good efficiency In terms of energy. However, this would be unproductive because the eye would not perceive this pixel with a good resolution.

To improve the resolution at this viewing angle α₂, the eye will naturally orient Its axis of gaze towards this angular direction. The eye rotates in Its orbit and therefore the pupil makes a spatial movement. With this movement, the centre of the pupil of the eye shifts from point C3₁ to point C3₂.

In this variant:
the screen comprises a first group of pixels that are similar to the pixel B1, and the emission axes of which converge to the first virtual point A1. The first pixel group makes it possible to form a first portion of the image In the eye box centred on the point C3₁. See FIG. 98.
the screen comprises a second group of pixels that are similar to the pixel B2, and the emission axes of which converge to the second virtual point A2. The second pixel group makes it possible to form a second portion of the image when the pupil is centred on the point C3₂: See FIG. 9D.

According to this embodiment, the user perceives the first portion of the image when his pupil occupies a first position (point C3₁), and the second portion of the image when his pupil occupies the second position (C3₂).

The first portion of the image and the second portion of the image are complementary: they correspond to two different portions of a wide-field image displayed by the device. Contrary to the embodiment described with reference to FIGS. 8A to 8G, it is not a question of duplicating the eye box, but rather of extending it spatially.

This embodiment allows the image to be observed while rotating the eye. Use is made of the fact that visual acuity is optimal in a central region of the retina, called the fovea. To cover the whole image, the eye rotates so that, at two different angular positions, the fovea perceives two different portions of the image projected by the screen.

Such a variant makes it possible to form a first portion of the image around the point C3₁, and an angularly offset second portion of the image around the point C3₂. The eye is able to perceive each portion of the image by rotating. This variant may be generalized to n different target points, n being greater than or equal to 2.

The invention may be integrated into a pair of glasses, or into a visor, or into a virtual-reality headset.

1. A device for projecting an image onto an eye, the device comprising:
a light emitter, configured to emit light waves along various respective emission axes;
an optical combiner, optically coupled to the light emitter, and configured to form, from each light wave emitted by the light emitter, a collimated light wave that propagates towards the pupil of the eye;
wherein:
the combiner has an object focal plane;
the light emitter comprises a directional screen, comprising various pixels, each pixel being configured to emit a divergent light wave along a predefined pixel emission axis, the light wave propagating such as to make a predefined pixel divergence angle to the pixel emission axis;
the directional screen is placed in the object focal plane of the combiner;
the optical combiner is configured to receive each light wave emitted by a pixel and to form a collimated light wave that propagates towards a position likely to be occupied by the pupil of the eye;
the respective pixel emission axes of various pixels of the directional screen converge to the same target point, downstream of the combiner;
the image of the target point, formed by the combiner, corresponds to the position likely to be occupied by the pupil of the eye.

2. The device of claim 1, wherein the screen comprises a stack comprising:
light guides, each light guide being coupled to a plurality of diffraction gratings, which are distributed over the length of the light guide, each diffraction grating being electrically modulatable, each diffraction grating being configured to be electrically modulated so as to extract light propagating through the light guide;
electrodes, each electrode being associated with a plurality of diffraction gratings coupled to various light guides, respectively, each electrode being configured to modulate each diffraction grating with which it is associated;
wherein
each pixel of the screen corresponds to an association between an electrode and a diffraction grating coupled to a light guide;
so that, under the effect of illumination by light extracted from the light guide, each pixel is configured to emit a divergent light wave that propagates around the pixel emission axis, thereby forming an emission cone, defined by a pixel divergence angle around the pixel emission axis.

3. The device of claim 1, wherein the screen comprises a holographic film, which is subdivided into various elementary regions, wherein
each elementary region is associated with the diffraction grating corresponding to one pixel;
each elementary region is configured to emit the divergent light wave, along the pixel emission axis and the pixel divergence angle of the pixel, under the effect of light extracted by the diffraction grating corresponding to said pixel.

4. The device of claim 2, wherein:
a plurality of light guides are connected to the same light source;
a light modulator les between the light source and each light guide, so as to modulate an Intensity of the light emitted by the light source and fed to the light guide.

5. The device of claim 2, comprising a plurality of light sources, each light source being optically connected to a plurality of light guides.

6. The device of claim 2, wherein various light sources are configured to emit light at various respective wavelengths.

7. The device of claim 2, wherein the pixels are arranged in:
rows, each row being defined by one light guide, the light guide extending over the length of various pixels in the row;
columns, each column being defined by one electrode, the electrode extending over the length of various pixels over the length of the column.

8. The device of claim 1, wherein:
the combiner extends around an optical axis;
the pixels of the screen are segmented into groups of pixels;
the pixel emission axes of a given group of pixels converge to the same target point associated with the group of pixels;
two different groups of pixels are associated with two different target points, at least one target point associated with a group of pixels being distant from the optical axis.

9. The device of claim 8, wherein:
the screen comprises a first group of pixels, the pixel emission axes of which converge to a first target point, the first group of pixels being configured to form a first portion of an image when the pupil of the eye occupies a first position;
the screen comprises a second group of pixels, the pixel emission axes of which converge to a second target point, different from the first target point, the second group of pixels being configured to form a second portion of the image when the pupil of the eye occupies a second position, angularly offset from the first position.

10. The device of claim 8, wherein:
the screen comprises a first group of pixels, the pixel emission axes of which converge to a first target point, the first group of pixels being configured to form an image when the pupil of the eye occupies a first position;
the screen comprises a second group of pixels, the pixel emission axes of which converge to a second target point, different from the first target point, the second group of pixels being configured to form the image when the pupil of the eye occupies a second position, different from the first position.

11. The device of claim 10, wherein:
the pixels of the screen are segmented into macro-pixels, the pixels of a given macro-pixel being configured to display the same content;
the pixel emission axes of a given macro-pixel target various target points.

12. The device of claim 1, wherein the combiner is a holographic combiner.

13. The device of claim 12, wherein:
the screen emits light in at least one emission spectral band;
the holographic combiner is transparent outside of the or each emission spectral band;
the holographic combiner forms a convergent lens In the or each emission spectral band.

14. The device of claim 13, wherein the holographic combiner forms a reflector in the or each emission spectral band.
